(19) United States
(12) Patent Application Publication
(10) Pub. No.: US 2012/0215345 A1
(43) Pub. Date: Aug. 23, 2012

(54) HAND-HELD DENTAL TOOL DISPENSING DEVICE WITH REMOVABLE DISPLAY

(76) Inventor: Ming-Yuan WU, Taipei City (TW)

(21) Appl. No.: 13/029,482

(22) Filed: Feb. 17, 2011

(51) Int. Cl. G06F 17/00

(52) U.S. Cl. 700/232

(57) ABSTRACT

A dispensing device for dispensing and storing disposable hand-held dental tools is disclosed. The hand-held dental tool dispensing device comprises a product display area for displaying dental tools or pictures of dental tools, product selection switches for selecting a dental tool for purchase, a payment exchange area for receiving payment, and a product retrieval area for retrieving purchased dental tools. The hand-held dental tool dispensing device further comprises a removable display for displaying information such as product information, instructional information, or advertising. The hand-held dental tool dispensing device further comprises an ultraviolet light module for performing sterilization procedures on the hand-held dental tools.

### BACKGROUND OF THE INVENTION

1. Field of the Invention

The present invention relates to dispensing equipment. More specifically, the present invention discloses a device for storing and dispensing dental tools and sterilizing the dental tools prior to dispensing in order to ensure suitable sanitary conditions of the purchased tools.

2. Description of the Prior Art

Dental professionals utilize a variety of hand-held tools to perform procedures to maintain a patient's teeth and to correct dental problems. The conventional dental tool includes a solid metal body with a metal implement on one end of the solid metal body.

However, after each use the dental tool must be sterilized before the dental tool is used with another patient in order to prevent contamination and possible infection or bacteria from being spread between patients. For example, if patient A has a virus and the dental tool used with patient A is not sterilized before using the dental tool with patient B, it is possible for patient B to contract the virus. As a result, use of the conventional dental tool has a potential risk of negatively affecting a patient's health.

There are various types of sterilization procedures, however, they typically require a relatively long time to perform, a high temperature, or hazardous chemicals or procedures. Some of these types of sterilizations with their associated disadvantages are:
sodium hydroxide—approximately 2 hours plus 1 hour autoclave;
heat—flame;
dry heat—high temperature and long time;
bleach—30 minutes, corrodes tool materials, solution must be routinely changed;
ozone—4-5 hours, hazardous;
formaldehyde—at least 1 day, expensive, short shelf life;
hydrogen peroxide—vapor is hazardous;
gamma rays—requires shielding, hazardous gamma rays;
ethylene oxide—3 hours, highly flammable, carcinogenic; and
chemical—damages plastic, harmful.

Additionally, there is an associated cost involved with the sterilization procedure, sterilization equipment, dental professional's time to perform the sterilization procedure, and detriment to the dental professional's health.

Additionally, dental professionals are required to have a storage room for storing the dental tools. This increases expenses for operation of the dental clinic.

Additionally, the stored dental tools must be sterilized before the first use. This is time consuming and expensive.

Furthermore, the dental tools stored in the storage room are susceptible to theft since the storage room is accessible.

Therefore, there is need for a safe and efficient device used by patients or for patients which dispenses disposable dental tools and ensures dental tools are sterile and sanitary.

### SUMMARY OF THE INVENTION

To achieve these and other advantages and in order to overcome the disadvantages of the conventional methods in accordance with the purpose of the invention as embodied and broadly described herein, the present invention provides a device for storing and dispensing sterile dental tools in order to ensure suitable sanitary conditions of the purchased tools.

The dispensing device of the present invention dispenses hand-held dental tools that are relatively inexpensive and are disposable after use in order to eliminate sterilization procedures and prevent contamination from being passed between patients.

The hand-held dental tool dispensing device of the present invention comprises a product display area, product selections switches or buttons, a payment exchange area, and a product retrieval area.

The product display area displays dental tools, samples of dental tools, or pictures of dental tools that are available for purchase.

The product selection switches are for selecting a dental tool for purchase. The user presses the associated product selection switch for the dental tool they want to purchase.

The payment exchange area is for receiving payment via coin currency, paper currency, or debit card. The payment exchange area also displays the cost of the selected dental tool, amount owed for purchase, or amount already received. A keypad is also provided for entering product number or code.

Dental tools are retrieved by the user from the product retrieval area after purchase.

The hand-held dental tool dispensing device further comprises a removable display for displaying information such as product information, instructional information, promotional video, or advertising. The removable display can be added to or removed from the hand-held dental tool dispensing device according to requirements.

The hand-held dental tool dispensing device further comprises an ultraviolet light module for performing sterilization procedures on the hand-held dental tools. This further ensures that the dental tools are sterilized and increases consumer confidence in the dental tools. Since the ultraviolet sterilization procedure is fast, effective, and inexpensive the ultraviolet light module of the present invention provides an efficient method of ensuring sanitary conditions of the dental tools.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification.

The drawings illustrate embodiments of the invention and, together with the description, serve to explain the principles of the invention. In the drawings:

FIG. 1 is a drawing illustrating a disposable hand-held dental tool according to an embodiment of the present invention;

FIG. 2 is a drawing illustrating a hand-held dental tool dispensing device according to an embodiment of the present invention;

FIG. 3 is a drawing illustrating a payment exchange area of a hand-held dental tool dispensing device according to an embodiment of the present invention;

FIG. 4 is a drawing illustrating a hand-held dental tool dispensing device with removable display according to an embodiment of the present invention;

FIG. 5 is a drawing illustrating a hand-held dental tool dispensing device with an ultraviolet light sterilization module according to an embodiment of the present invention; and

FIG. 6 is a drawing illustrating a hand-held dental tool dispensing device with an ultraviolet light sterilization module and sterilizing area according to an embodiment of the present invention.

### DESCRIPTION OF THE PREFERRED EMBODIMENTS

Reference will now be made in detail to the preferred embodiments of the present invention, examples of which are illustrated in the accompanying drawings.

Wherever possible, the same reference numbers are used in the drawings and the description to refer to the same or like parts.

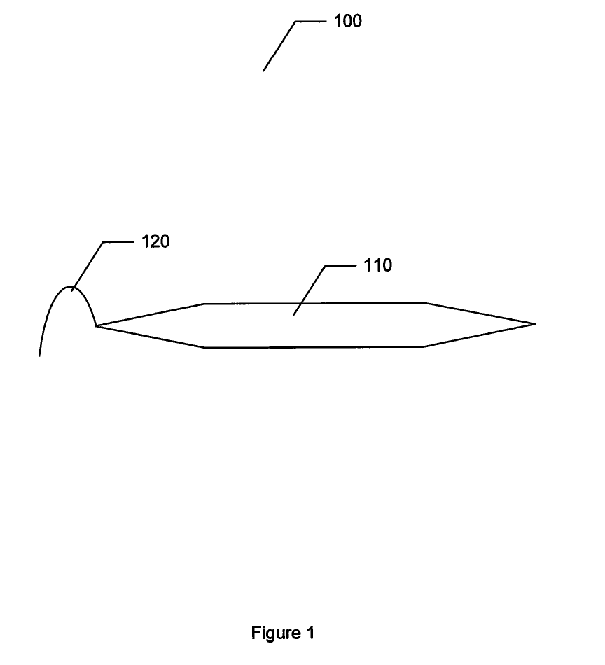

Refer to FIG. 1, which is a drawing illustrating a disposable hand-held dental tool according to an embodiment of the present invention.

The disposable hand-held dental tool 100 comprises a main body 110 and at least one implement 120 for performing dental procedures on patients.

Since the main body 110 comprises an inexpensive material, for example plastic, the dental tool 100 is disposed of after use. As a result, the hand-held dental tool 100 is used with only one patient before being discarded. This prevents bacteria, contamination, and viruses from being passed to other patients.

After manufacture the hand-held dental tool 100 is sterilized by, for example, a gamma ray sterilization procedure at the production factory. The hand-held dental tool is then packaged individually or packaged together with other dental tools. For example, a variety of different dental tools are packaged together as a variety pack.

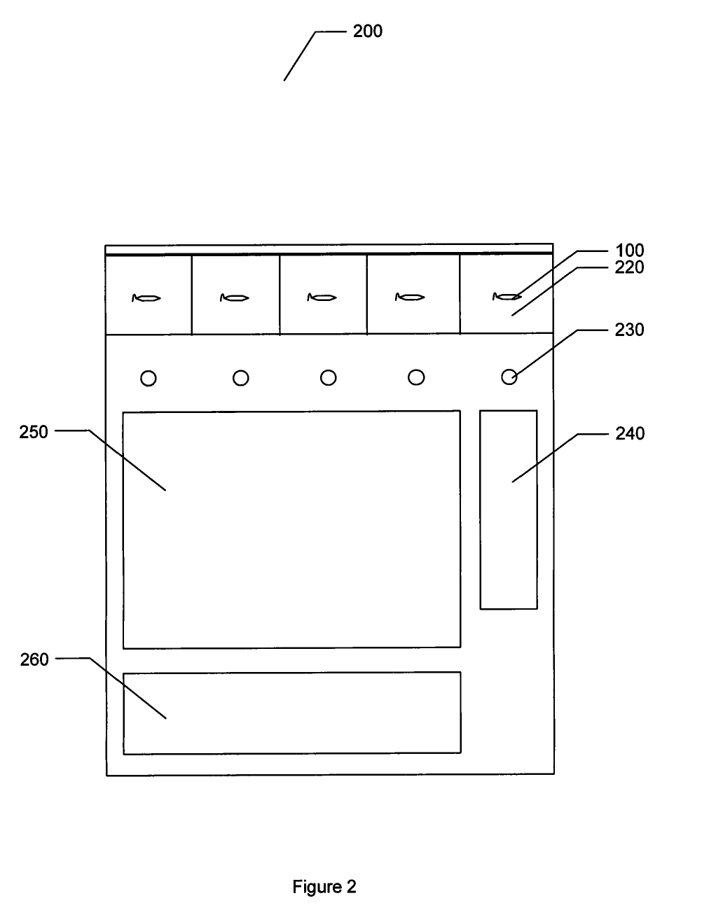

Refer to FIG. 2, which is a drawing illustrating a hand-held dental tool dispensing device according to an embodiment of the present invention.

As shown in FIG. 2, the hand-held dental tool dispensing device 200 comprises a product display area 220, a plurality of product selection switches 230, a payment exchange area 240, and a product retrieval area 260.

The product display area 220 comprises a picture or photograph of the dental tool 100, a sample of the dental tool 100, or an actual dental tool 100 available for purchase. For example, a picture of the dental tool 100 is provided so the user can identify which product they wish to purchase or obtain. Or, for example, a sample of the dental tool 100 is provided and when the user selects a dental tool sample, the actual dental tool purchased is obtained from the product retrieval area 260 and the dental tool sample remains in the product display area 220. Or, for example, the actual dental tool 100 is displayed in the product display area 220 and when selected, the actual dental tool 100 drops into the product retrieval area 260 and a new actual dental tool 100 is displayed in the product display area 220.

In an embodiment of the present invention the product display area 220 further comprises an indication of the cost of the dental tool.

In an embodiment of the present invention the hand-held dental tool dispensing device 200 further comprises a product storage area 250 for storing an inventory of dental tools 100. After a user submits payment for the desired dental tool 100, one of the appropriate dental tools stored in the product storage area 250 drops into the product retrieval area 260 and the user can then retrieve the purchased dental tool 100.

In an embodiment of the present invention the product display area 220 fulfills the purpose of the product storage area 250 since the retrieved dental tool 100 is an actual dental tool 100 for purchase. An inventory of actual dental tools are stored and displayed in the product display area 220.

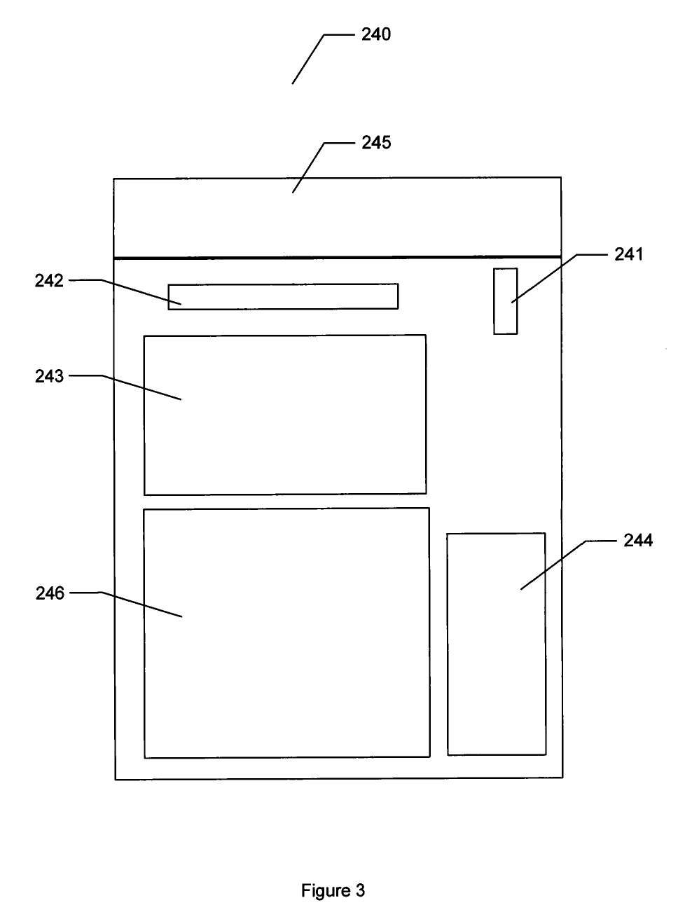

Refer to FIG. 3, which is a drawing illustrating a payment exchange area of a hand-held dental tool dispensing device according to an embodiment of the present invention.

The payment exchange area 240 enables exchanges of payment for purchases of products between users and the hand-held dental tool dispensing device.

In the embodiment illustrated in FIG. 3, the payment exchange area 240 comprises a payment display 245, a coin currency input 241, a bill currency input 242, and a change return 244.

The payment exchange area 240 further comprises a payment exchange controller for interfacing between and controlling the payment display 245, the coin currency input 241, and the bill currency input 242.

The coin currency input 241 allows users to insert coins into the coin currency input 241 of the hand-held dental tool dispensing device in order to make payment for a selected dental tool. This is convenient for users when the cost of a particular dental tool is very inexpensive. The coin currency input 241 comprises means for accepting coins that are input by the user, detecting the denomination of the coins, storing the coins, providing coins to the change return 244 when change is due the user, and informing the payment exchange controller of the denomination of a received coin.

Similarly, the paper currency input 242 allows users to make payment with paper currency. This payment method is more efficient when purchasing dental tools that are more expensive and reduces the effort required instead of purchasing using coins. The paper currency input 242 comprises means for accepting paper currency that is input by the user, detecting the denomination of the paper currency, storing the paper currency, and cooperates with the payment exchange controller regarding the denomination of received paper currency.

The change return 244 receives appropriate coins for returning change to the user after purchasing a dental tool and allows the user to retrieve their change.

The payment display 245 is, for example, a small LCD or LED display. The payment display 245 shows the amount of money owed in order to purchase a selected dental tool, the amount of money received, or both the amount of money owed and amount of money received. As each coin or piece of paper currency is received, the payment display 245 is updated to reflect the current amount of money received and/or owed.

In an embodiment of the present invention the payment exchange area 240 further comprises a keypad 246 for entering product selection data. In this embodiment an indicator of the product number for each dental tool is displayed in the product display area 220 and the keypad 246 acts as the product selection switches 230. The user identifies which dental tool they want to purchase by noting the product number in the product display area 220 and enters the product number using the keypad 246. The payment exchange controller detects the entered product number and displays the amount of money required to purchase the dental tool on the payment display 245.

In an embodiment of the present invention the payment exchange area further comprises a debit card input 243 for receiving payment from a debit card. The debit card input 243 and/or the payment exchange controller determines how much money is owed for the purchase, determines if the debit card has sufficient funds to cover the purchase, and deducts the amount owed from the funds stored in the debit card.

If a personal identification number (PIN) or password is required in order to use the debit card, the PIN or password is entered via the keypad 246.

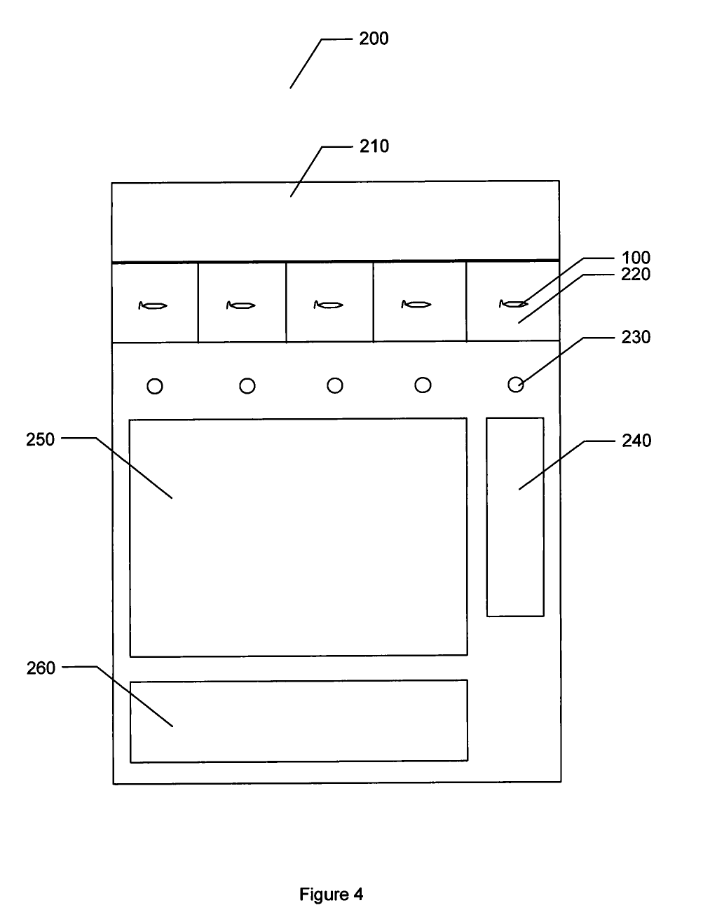

Refer to FIG. 4, which is a drawing illustrating a hand-held dental tool dispensing device with removable display according to an embodiment of the present invention.

The embodiment of the present invention illustrated in FIG. 4 is similar to the embodiment of FIG. 2. However, in the embodiment illustrated in FIG. 4 the hand-held dental tool dispensing device 200 further comprises a removable display 210.

The removable display 210 can be added to or removed from the hand-held dental tool dispensing device 200 to increase flexibility of application or use.

The removable display 210 allows the hand-held dental tool dispensing device 200 to display information such as, for example, product information, instructional information, advertising, or a combination of different types of information. In an embodiment of the present invention the removable display 210 is an electronic display that is capable of displaying video or multimedia presentations.

An application of the removable display 210 is displaying advertisements of the dental tools available for purchase from the hand-held dental tool dispensing device 200. Another application of the removable display 210 is displaying instructional videos of how to use the dental tools. Another application of the removable display 210 is displaying promotional videos of how the dental tools are manufactured or the benefits and advantages of the dental tools.

Although the removable display 210 can be removed, the removable display is secured in a manner in order to prevent theft of the removable display 210.

The removable display 210 can be added or removed according to application requirements or cost concerns.

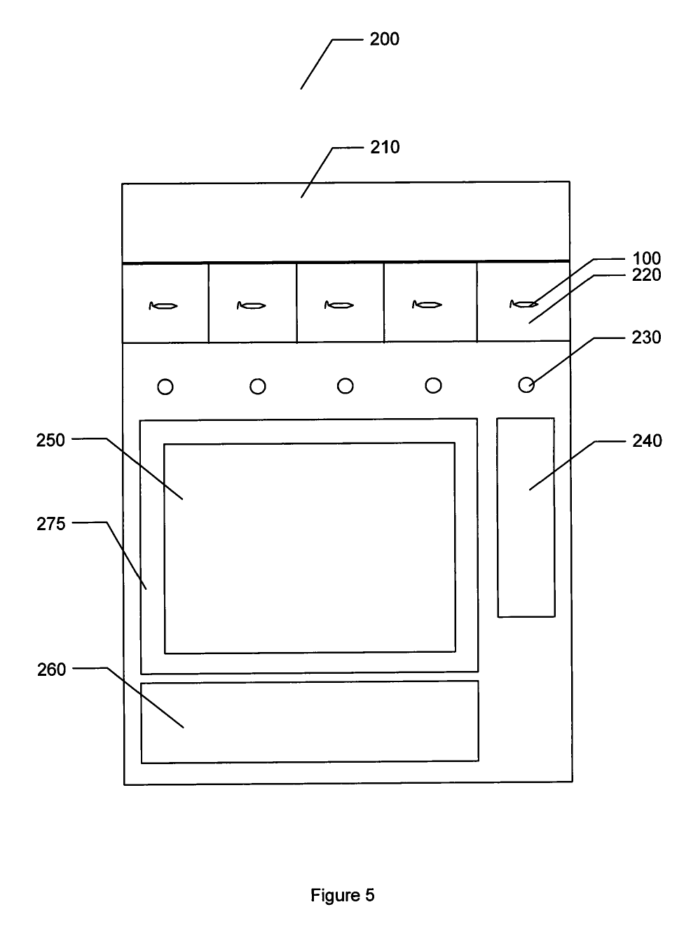

Refer to FIG. 5, which is a drawing illustrating a hand-held dental tool dispensing device with an ultraviolet light sterilization module according to an embodiment of the present invention.

In the embodiment illustrated in FIG. 5, the hand-held dental tool dispensing device 200 further comprises an ultraviolet light module 275. In this embodiment the ultraviolet light module 275 is provided for performing sterilization procedures on the hand-held dental tools stored in the product storage area 250.

The ultraviolet light module 275 comprises a lamp or a plurality of lamps, for example, a mercury-vapor lamp that emits ultraviolet light at the germicidal wavelength.

The ultraviolet light module 275 sterilizes the dental tools by breaking down micro-organisms. Ultraviolet light has a short wavelength that is harmful to microorganisms and destroys their nucleic acids. The ultraviolet radiation disrupts the microorganisms' DNA thereby killing them by eliminating their reproductive capabilities. Microorganisms cannot survive prolonged exposure to ultraviolet light.

In the embodiment illustrated in FIG. 5, the ultraviolet light module 275 is positioned so that it surrounds the inventory of dental tools or positioned in front of, in back of, above, below, on sides of the dental tools. In embodiments of the present invention the ultraviolet light module 275 is disposed in a combination of positions.

Since reflection increases the effectiveness of the ultraviolet sterilization, in embodiments of the present invention the ultraviolet light module 275 further comprises metal, for example, aluminum that is used to increase ultraviolet reflection and intensity.

Although the dental tools have been sterilized prior to packaging, the sterilization procedures are performed at periodic or intermittent times by the ultraviolet light module 275 to further ensure that the dental tools remain sterilized.

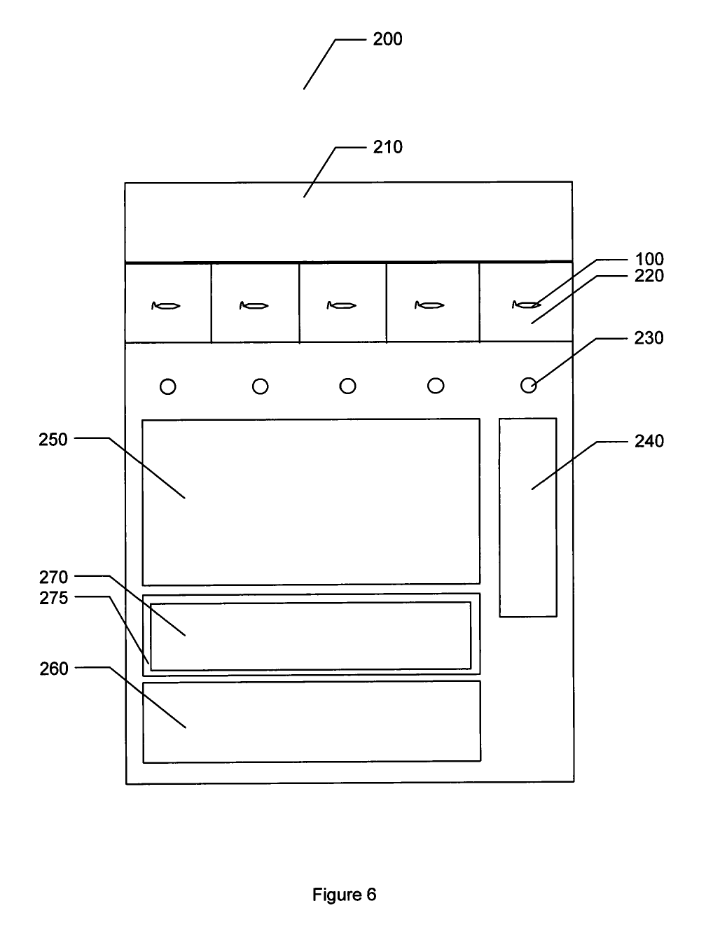

Refer to FIG. 6, which is a drawing illustrating a hand-held dental tool dispensing device with an ultraviolet light sterilization module and sterilizing area according to an embodiment of the present invention.

The embodiment illustrated in FIG. 6 is similar to the embodiment illustrated in FIG. 5, however, in the embodiment illustrated in FIG. 6 the hand-held dental tool dispensing device 200 further comprises an ultraviolet sterilization area 270.

In this embodiment the ultraviolet light module 275 is positioned in or around the ultraviolet sterilization area 270. Once a dental tool has been purchased, the dental tool drops into the ultraviolet sterilization area 270 from the product storage area 250 or the product display area 220 (if the product display area is acting as the product storage area). Then, the ultraviolet light module 275 performs a sterilization procedure on the dental tool in the ultraviolet sterilization area 270. After the sterilization procedure is complete the sterilized dental tool drops into the product retrieval area 260 and the user retrieves their purchased dental tool.

In this embodiment all external surfaces of the dental tool are sterilized. Additionally, the sterilization procedure is performed only on purchased dental tools and at the time of purchase. Furthermore, users are additionally ensured that the dental tool they purchased has been sterilized.

In an embodiment of the present invention the ultraviolet light module 275 is disposed in the product retrieval area 260. Once a dental tool has been purchased, the dental tool drops into the product retrieval area 260 and the ultraviolet light module 275 performs a sterilization procedure on the dental tool. A door on the product retrieval area 260 remains locked until the sterilization procedure is complete. This prevents the user from retrieving the dental tool while the ultraviolet light module is turned on.

Additionally, a sterilization procedure in operation indicator such as a light is provided to inform users that a sterilization procedure is currently being performed and to inform users that the sterilization procedure is complete.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A hand-held dental tool dispensing device comprising:
a product display area for displaying at least one hand-held dental tool;
at least one product selection switch for selecting one of the at least one hand-held dental tool;
a payment exchange area for receiving payment in exchange for one of the at least one hand-held dental tool; and
a product retrieval area for allowing purchased hand-held dental tools to be retrieved from the hand-held dental tool dispensing device.

2. The hand-held dental tool dispensing device of claim 1, further comprising:
a product storage area for storing hand-held dental tools;

3. The hand-held dental tool dispensing device of claim 1, further comprising:
a removable display for displaying product information, advertising, instructional information, or a combination of product information, advertising, and instructional information.

4. The hand-held dental tool dispensing device of claim 1, further comprising:
an ultraviolet light module for performing a sterilization procedure on hand-held dental tools.

5. The hand-held dental tool dispensing device of claim 1, the payment exchange area comprising:
a payment display for displaying amount of money owed, amount of money received, or amount of money owed and amount of money received;
a coin currency input for receiving payment in coins;
a paper currency input for receiving payment in paper currency; and
a change return for returning change.

6. The hand-held dental tool dispensing device of claim 5, the at least one product selection switch comprising a keypad for entering product selection data, the keypad located in the payment exchange area.

7. The hand-held dental tool dispensing device of claim 5, the payment exchange area further comprising:
a debit card input for receiving payment from a debit card.

8. The hand-held dental tool dispensing device of claim 1, the product display area displaying a hand-held dental tool picture, a hand-held dental tool sample, or a hand-hold dental tool for purchase.

9. A hand-held dental tool dispensing device comprising:
a product display area for displaying hand-held dental tools;
at least one product selection switch for selecting one of the hand-held dental tools;
a product storage area for storing hand-held dental tools;
a payment exchange area for receiving payment in exchange for one of the hand-held dental tools; and
a product retrieval area for allowing purchased hand-held dental tools to be retrieved from the hand-held dental tool dispensing device.

10. The hand-held dental tool dispensing device of claim 9, further comprising:
a removable display for displaying product information, advertising, instructional information, or a combination of product information, advertising, and instructional information.

11. The hand-held dental tool dispensing device of claim 9, further comprising:
an ultraviolet light module for performing a sterilization procedure on hand-held dental tools.

12. The hand-held dental tool dispensing device of claim 9, the payment exchange area comprising:
a payment display for displaying amount of money owed, amount of money received, or amount of money owed and amount of money received;
a coin currency input for receiving payment in coins;
a paper currency input for receiving payment in paper currency; and
a change return for returning change.

13. The hand-held dental tool dispensing device of claim 12, the at least one product selection switch comprising a keypad for entering product selection data, the keypad located in the payment exchange area.

14. The hand-held dental tool dispensing device of claim 12, the payment exchange area further comprising:
a debit card input for receiving payment from a debit card.

15. The hand-held dental tool dispensing device of claim 9, the product display area displaying a hand-held dental tool picture, a hand-held dental tool sample, or a hand-hold dental tool for purchase.

16. A hand-held dental tool dispensing device comprising:
a product display area for displaying at least one hand-held dental tool;
at least one product selection switch for selecting one of the at least one hand-held dental tool;
a payment exchange area for receiving payment in exchange for one of the at least one hand-held dental tool;
a product retrieval area for allowing purchased hand-held dental tools to be retrieved from the hand-held dental tool dispensing device; and
a removable display for displaying product information, advertising, instructional information, or a combination of product information, advertising, and instructional information.

17. The hand-held dental tool dispensing device of claim 16, further comprising:
an ultraviolet light module for performing a sterilization procedure on hand-held dental tools.

18. The hand-held dental tool dispensing device of claim 16, the payment exchange area comprising:
a payment display for displaying amount of money owed, amount of money received, or amount of money owed and amount of money received;
a coin currency input for receiving payment in coins;
a paper currency input for receiving payment in paper currency; and
a change return for returning change.

19. The hand-held dental tool dispensing device of claim 18, the at least one product selection switch comprising a keypad for entering product selection data, the keypad located in the payment exchange area.

20. The hand-held dental tool dispensing device of claim 16, the product display area displaying a hand-held dental tool picture, a hand-held dental tool sample, or a hand-hold dental tool for purchase.
